(19) United States
(12) Patent Application Publication
(10) Pub. No.: US 2014/0196066 A1
(43) Pub. Date: Jul. 10, 2014

(54) Data Highlighting and Extraction

(71) Applicants: Gansha Wu, Beijing (CN); Dan Zhang, Beijing (CN); Biao Chen, Beijing (CN); Yongjian Chen, Yongiian (CN); Peng Guo, Beijing (CN); Zhanglin Liu, Beijing (CN); Zhigang Wang, Beijing (CN); Xin Zhou, Beijing (CN)

(72) Inventors: Gansha Wu, Beijing (CN); Dan Zhang, Beijing (CN); Biao Chen, Beijing (CN); Yongjian Chen, Yongiian (CN); Peng Guo, Beijing (CN); Zhanglin Liu, Beijing (CN); Zhigang Wang, Beijing (CN); Xin Zhou, Beijing (CN)

(21) Appl. No.: 13/991,207

(22) PCT Filed: Dec. 13, 2010
(86) PCT No.: PCT/CN10/02025

§ 371 Date: Dec. 30, 2013

(51) Int. Cl. H04N 21/24

(52) U.S. Cl. CPC H04N 21/2407
USPC 725/14

(57) ABSTRACT

We are facing an explosion in availability of online content, in particular accessing audio, video, and other data is considered to be driving the expansion of the Internet to accommodate access needs. However, time availability for accessing such data remains constrained and it is becoming more imperative that a technology be utilized to package the data for example, as a Collective Cut, to facilitate its consumption by pre-identifying portions of the data that are expected to be interesting to a consumer. Such packaging has many possibilities. For example, in the audio context, audio data could be presented to a consumer with specific portions of an audio presentation highlighted as the best portions to listen to if the consumer lacks sufficient time to listen to the entire presentation. In the video context, video highlights for a movie or other consumable data may be provided, allowing a consumer to electively skip through the highlights if there is insufficient time and/or interest in viewing the entire presentation.

### FIELD OF THE INVENTION

The invention generally relates to annotating and reviewing consumable data such as any electronically accessible entertainment, and more particularly to applying the collective activity of consumers effort to identify interesting regions of consumable data to facilitate identifying annotations or “highlights” for the consumable data.

### BACKGROUND

Current trend analysis suggests streamed consumable data will become a dominant distribution technique. In-Stat, LLC (see http://www.instat.com), a company providing analysis and forecasts of digital media and content, including video streaming, downloads and digital TV, estimates streaming and online access of consumable data is preferred by audience members over retail disc sales as the major distribution channel for people to receive consumable data in future digital entertainment delivery. This represents a rapid growth in online consumable data access, as exemplified by statistics provided by Cisco showing Internet video is approximately one-quarter of all non-peer-to-peer consumer Internet traffic, and it is expected that in 2012, Internet video traffic will be nearly 400 times the data usage for the entire U.S. Internet backbone in the year 2000 (see http://www.cisco.com/en/US/solutions/collateral/ns341/ns525/ns537/ns705/ns827/white_paper_c11-481374_ns827_Networking_Solutions_White_Paper.html). Similarly, the New York Times newspaper estimated that YouTube's 2007 video traffic alone exceeded the total Internet traffic for the United States in the year 2000 (see, e.g., http://www.nytimes.com/2008/03/13/technology/13net.html).

Existing research has resulted in numerous technologies, such as video analytics and applying artificial intelligence to consumable data, in an effort to better understand and recognize consumable data content. See, for example, TREC Video Retrieval Evaluation at http://trecvid.nist.gov, a conference sponsored by the National Institute of Standards and Technology (NIST) with support from other U.S. government agencies. The goal of TREC is to encourage information retrieval research; in 2001 and 2002 TREC provided video data to assist research in automatic segmentation, indexing, and content-based retrieval of digital video. However, this and other technologies have been unsuccessful in, for example, trying to identify areas of heightened interest to a particular audience.

### BRIEF DESCRIPTION OF THE DRAWINGS

The features and advantages of the present invention will become apparent from the following detailed description of the present invention in which:

FIG. 1 illustrates according to one embodiment monitoring one audience member input with which interactive audience analysis may be employed to prepare a Collective Cut from the activity of one or more audience members.

FIG. 2 illustrates according to one embodiment continuing to monitor audience member input with which interactive audience analysis may be employed to prepare the Collective Cut.

FIG. 3 illustrates, according to one embodiment, a consumer seeking the next interesting region of the consumable data.

FIG. 4 illustrates in part, according to one embodiment, the cumulative effect of the FIGS. 1-3 highlighting of interesting regions of a consumable data.

FIG. 5 illustrates a data flow diagram, according to one embodiment, for pre-annotating consumable data.

FIG. 6 illustrates, according to one embodiment, continuing to apply multiple consumer access of consumable data to identify interesting regions.

FIG. 7 illustrates the result of all consumers of FIGS. 1-4, 6 identifying interesting regions and/or modifying regions identified by other consumers.

FIG. 8 illustrates a suitable computing environment in which certain aspects of the invention may be implemented.

### DETAILED DESCRIPTION

Various embodiments of the invention concern utilizing collective behavior to improve identification results. In various illustrated embodiments an effort is made to identify regions of interest within an audio, video or other consumable/accessible data; the phrase “consumable data” will be used to collectively refer to such data, and it is intended to refer to data that is stored in any state preserving media or medium and that may be singly or multiply or simultaneously accessed. Consumable data may represent, for example, stored and/or streamed video or audio data, as well as individual frames, sections, portions, cuts, etc. of such audio, video, etc. data. It will be appreciated by one skilled in the art that audio and video data are presented for exemplary purposes and any data collection in which portions of interest may be identified by one or more entities are intended to be within the scope of the recited embodiments.

It will be appreciated that “interest” is a relative term that may have a different meaning depending on the intended audience, e.g., what is interesting to an adult audience may be very different than what is interesting to a young adult audience. Thus, even if not specifically called out below, it should be appreciated by one skilled in the art the same techniques described herein may give different results depending on the nature of the audience performing the described operations, and that results from diverse audiences may be selectively combined as desired.

In the illustrated embodiments, it is assumed interactive behaviors of a target audience (or audiences) are monitored as members of the audience interact with consumable data. This monitoring may be performed in real or near-real time as audiences interact with consumable data. Or, monitoring may occur after the fact based on data accumulated with respect to a particular viewing or data consumption experience. For convenience in describing various features of the inventive concepts presented herein, it will be assumed an audience is interacting with a video, such as a recorded (or buffered) video broadcast or electronically accessible movie. However, as discussed above, the principles herein apply to any consumable data. Through monitoring collective audience interaction, a collective intelligence can be harnessed to identify meaningful regions within consumable data, e.g., audio, video, etc. Meaningful regions for a video could be, for example, segments of a video (typically referred to as video highlights) identified as being interesting.

The phrase “interactive audience analysis” or IAA, may be used to refer to analysis performed on the actions of the target audience(s). IAA differs from, for example, current automated video analytics technologies such as those that attempt to extract video highlights based on automated computer vision, machine learning and other artificial intelligence technologies. It will be appreciated automated video analytics technology and the disclosed embodiments need not be mutually exclusive, e.g., the disclosed embodiments may be utilized in conjunction with video analytics. It will be appreciated video analytics may be performed before, during or after the IAA, e.g., video analytics may be a pre, post, or interim processing stage depending on the needs and/or goals of the IAA.

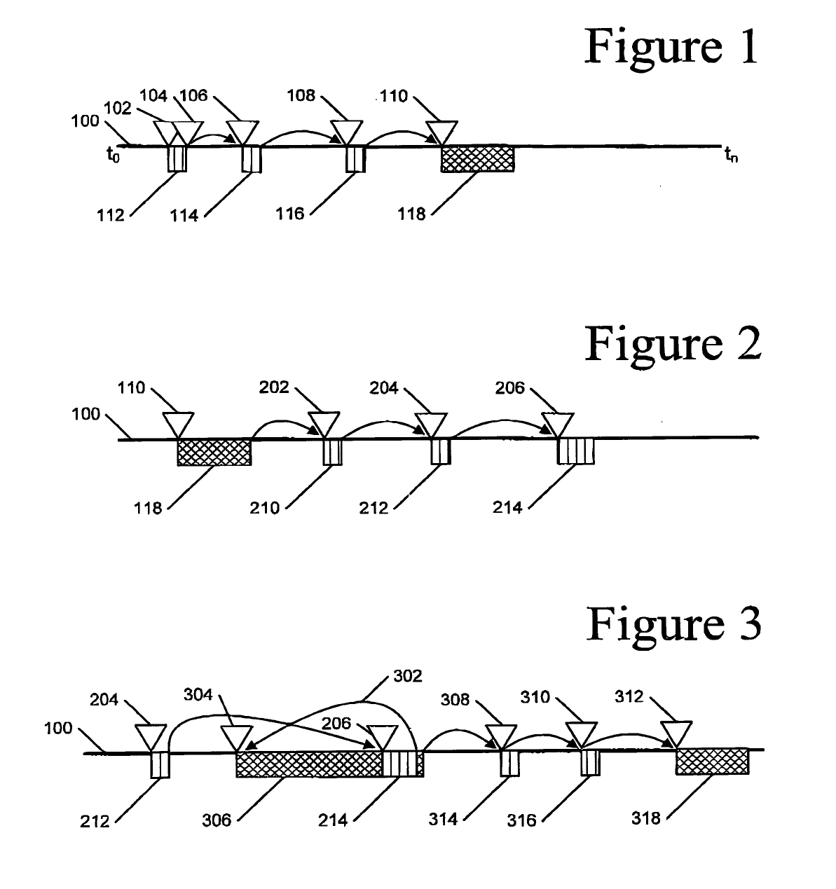

FIG. 1 illustrates according to one embodiment monitoring one audience member input with which interactive audience analysis (IAA) may be employed to prepare a Collective Cut from the activity of one or more audience members. The phrase Collective Cut (CT) may be used to generally refer to identified regions of interest within consumable data. As discussed above, in some embodiments (not illustrated), video analytics may be used to facilitate determining the CT.

In the illustrated embodiment, it is assumed audience members are being monitored as they interact with streamed consumable data. This is a simplification assumption since it is typically easier to monitor access to streamed data, e.g., attempts to seek within a data stream can be determined by watching the commands to move within a stream that needs to be provided from an external source, However, it will be appreciated existing/stored content may be similarly monitored through use of hardware and/or software enabled devices configured to monitor data corresponding to seeking within a stream, and providing, e.g., by way of sending (pushing) the monitored data or allowing it to be accessed (pulled), the monitored data to an external entity, such as a cable television or satellite broadcast head end, Internet server (which may also provide streamed consumable data), etc.

As illustrated in FIG. 1, there is a timeline 100 organized such that t₀<tₙ and therefore to represents a moment in time before tₙ. The amount of time between t₀ and tₙ is arbitrary, but the figure illustrates presentation of consumable data over a certain period of time, e.g., it may represent the entire presentation of the consumable data or only one or more subsets thereof. For increased simplicity, the t₀ and tₙ markers are left off the remaining figures. As shown, there are timing markers 102-110. In the illustrated embodiment, it is assumed at any given time there is a current play position indicating where in the consumable data a certain audience member is currently viewing the consumable data. Timing markers 102-110 represent various moments in time that at some point in time were the current play position. For example, after initiating streaming of consumable data, an audience member may drag the current play initially to position 102 and consume the consumable data for some arbitrary region 112 of time as desired by the audience member, where viewing was stopped at marker 104, e.g., by way of stopping viewing, skipping ahead, dragging the current play position from marker 104 to another location, etc.

One consecutive (or relatively consecutive) consumption time of the consumable data is, as noted above, represented with the illustrated region 112. Region 112 has a width representing a length of time of consuming the consumable data. It is expected the length of time is less than (tₙ−tₒ), otherwise the audience member would have consumed the entire consumable data. It will be appreciated that if the consumable data is video data, then the region 112 represents the amount of time of the video that has been watched, and if the consumable data is audio data, it represents the amount of time to which the audio data was listened. In the illustrated embodiment, it is expected the audience member may use a “fast forward” type of control, skip button or feature, or directly drag a currently play position marker, to move consumption of the consumable data from timing marker 104 indicating the end of the consumed region 112 to some other marker location, such as to marker 106, to skip over content within the consumable data considered less interesting, and allow accessing more interesting content. In the illustrated embodiment, movement of the current play marker within the consumable data represents a judgment or opinion of an audience member on whether a particular section of the consumable data is worth consuming, e.g., worth viewing, listening, reading, etc. as determined by the type of consumable data.

As with region 112, in the illustrated embodiment, marker 106 identifies the start of another region 114 representing more interesting content. At some point in time (not illustrated) the consumable data consumer moves the current play marker and skips to timing marker 108 and again watches or otherwise consumes another region 116 of consumable data. This repeats again where the current play jumps to timing marker 110, at which point the consumable data must have been interesting because a larger region 118 (larger with respect to the other regions 112-116) of the consumable data is viewed or otherwise consumed.

FIG. 2 illustrates according to one embodiment continuing to monitor audience member input with which interactive audience analysis (IAA) may be employed to prepare a Collective Cut (CT). It will be appreciated when people watch an interesting video, re-listen to music, or otherwise re-consume consumable data, they may desire to repeat the data consumption, but will have a focus on portions of the consumable data considered particularly interesting during the previous consuming.

In the illustrated embodiment, it is assumed a consumer utilizes a fast forward/rewind, skip feature or button, or other technique to change the current play position. When access to the consumable data is for a subsequent, e.g., 2^{nd}, 3^{rd}, etc. time, it is assumed the consumer's judgment on what is an interesting region, e.g., a “highlight”, within the data is more accurate. Service providers may track the collective behaviors of a large group of consumers, and use the subsequent consumptions to refine what is considered interesting within a particular consumable data. For example, the most popular movie on youku.com (a Chinese video streaming site) is usually watched by more than 3,000,000 times, representing an enormous number of consumers that may be monitored, The service provider may monitor and learn how consumers extract highlights, and determine a collective judgment for the consumption. In selected embodiments determining a collective judgment is an iterative and adaptive process. In the illustrated embodiment, after consumption has identified the larger region 118, the consumer continues to consume the data, such as by skipping the current play marker to locations 202-206 and respectively watching or otherwise consuming data portions 210-214.

FIG. 3 illustrates, according to one embodiment, a consumer seeking the next interesting region (e.g., the next highlight) of the consumable data.

The embodiment represents the consumer, after watching or otherwise consuming for some period of time as illustrated in FIG. 2, the consumer concludes some interesting regions of the consumable data have been missed. As illustrated, the consumer has obtained FIG. 2 portions 212, 214 and then decides to move 302 the current play marker back to a time marker 304 before time marker 206 that will be determined to be an interesting region within the consumable data. This highlight 306 includes the FIG. 2 region 214 previously considered an interesting region of the consumable data.

As with FIGS. 1-2, the consumer skips around within the consumable data, moving from the end of interesting region 306 to time marker 308, consumes some data and skips to time marker 310 and then again to time marker 312. These actions define the illustrated interesting regions 314, 316, 318 having varying lengths of time for their consuming based on factors deemed pertinent to the consumer, e.g., based on likes, dislikes, curiosity, requirement, work, etc. completes his/her annotation of highlights (e.g. four segments of highlights below). As discussed above, interactive audience analysis may be used to analyze consumer activity in preparing a CT.

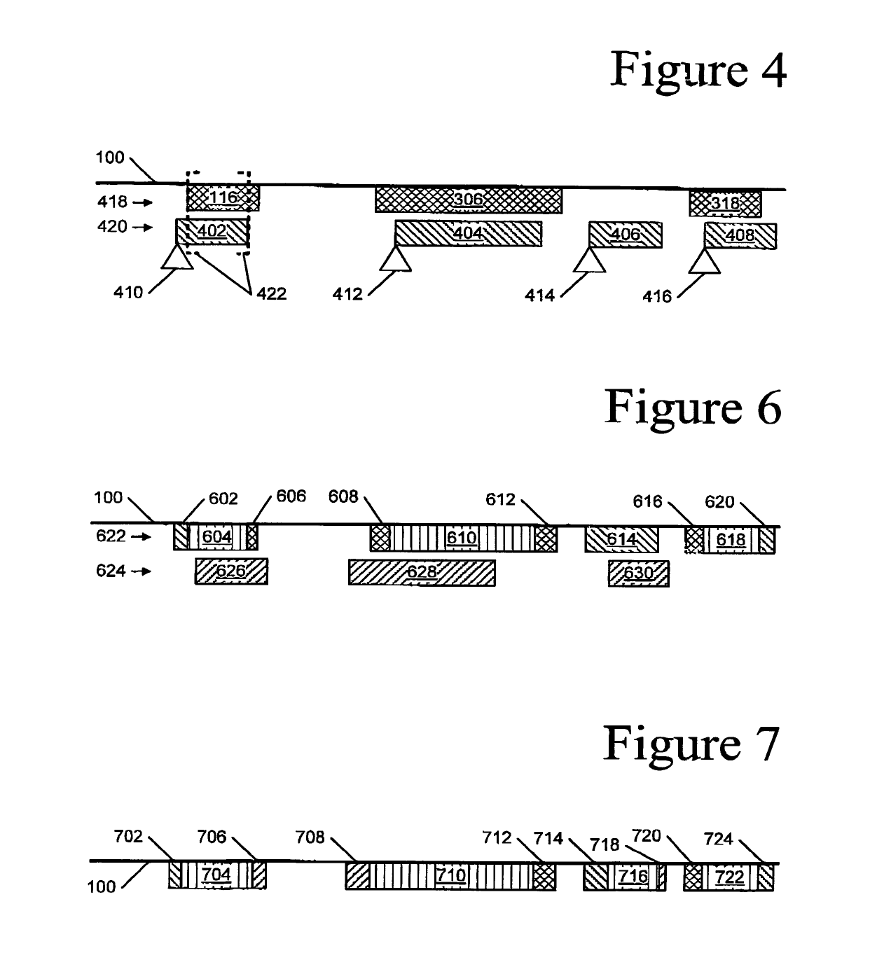

FIG. 4 illustrates in part, according to one embodiment, the cumulative effect of the FIGS. 1-3 highlighting of interesting regions 116, 306, 318 of a consumable data. Assume in the FIG. 4 embodiment regions 116, 306, 318 were determined by a first consumer (or multiple aggregated or related consumers); these regions are all filled with the same cross pattern. The illustrated regions 402-408 are also interesting regions identified as in FIGS. 1-3, but by monitoring a second consumer's traversal across timeline 100 and the viewing regions identified by time markers 410-416; these regions share the same left-diagonal pattern.

With such multiple consumer inputs, a service provider or other entity can combine the input to perform interactive audience analysis (IAA). Note that while the FIG. 4 embodiment only illustrates two collections 418, 420 of regions from two consumers, e.g., respectively regions 116, 306, 318 and regions 402-408, it will be appreciated an arbitrary number of consumer inputs can be utilized to perform the IAA. In one embodiment, IAA includes creating a weighted value for regions, where the overlapping portions of regions are given a cumulative weight of the values assigned to the individual overlapping regions, e.g., overlapping is cumulative, regions with highest values after monitoring and analyzing multiple consumptions can be considered more reliably interesting to the target audience(s) being monitored.

In one embodiment, this weighting can be defined with respect to a set such that: {[t₁, duration₁, weight₁], [t₂, duration₂, weight₂], . . . , [tₙ, durationₙ, weightₙ]}, where after determining the first region collection 418, n=3 and the value for the regions 116, 306, 318 are pre-assigned to be 1 for the first consumer of the consumable data, e.g., the first viewer of a video. In one embodiment, when a second consumer accesses the consumable data and generates the second collection 420 of interesting regions, each of the second consumer's regions are also assigned a value of 1 for the second consumer's consumption, but an overlapping regions, e.g., the portion 422 identified by dashed brackets, assuming simple addition, that region would be assigned a value of 2. Over time, after many consumers access the consumable data, there will be certain regions of the consumable data that are statistically considered significantly more interesting to the aggregate audience that consumed the data.

In one embodiment, region weightings will be f(N) if the consumer has consumed the entire consumable data N times, e.g., watched a “full-length” video N times, where N>1 and f(N)>>1 (much greater than 1) so as to give great weight to the presumed accuracy of interesting region identification by consumers having knowledge of the entire consumable data from multiple entire consumption, e.g. from having watched an entire video multiple times. It will be appreciated that a service provider may offer some incentive, discount, coupon, or the like, e.g., a microeconomic stimulus, to encourage complete consumption and interesting region identification.

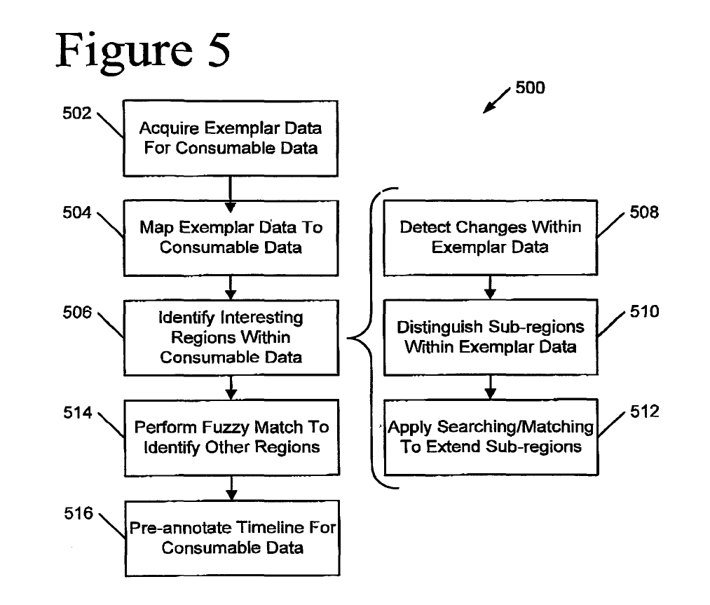

FIG. 5 illustrates a data flow diagram 500, according to one embodiment, for pre-annotating consumable data In the FIG. 1-4 embodiments, it can been assumed region weightings were initially zero because there were no regions defined and hence the first consumption, e.g. first video watching, resulted in an initial, e.g., 1, weighting for a first consumer's identified regions. However, a first consumer need not start with a blank timeline. A service provider, intermediary device along a transmission path or data path to the consumer, endpoint device utilized by the consumer, or other device, may pre-annotate a timeline 100 with interesting regions, e.g., provide pre-existing highlights.

For example, if the consumable data includes a publicly released video such as a movie, one can acquire 502 data identifying interesting portions of consumable data, which for a movie would typically include trailers and other advertising regarding the movie. The acquired data can then be mapped 504 against the consumable data to identify 506 interesting regions within the consumable data. The phrase “exemplar data” will be used herein to refer to any data concerning the consumable data that may be mapped 504 to identify 506 interesting regions within the consumable data.

For the movie, exemplar data includes the trailers and other advertising regarding the movie, and video analytics may be employed to match exemplar data to the movie to identify the region or regions within the consumable data corresponding to the exemplar data. Movie trailer type of exemplar data are typically a “Director's Cut” of highlights, but they are usually combined into a single end-to-end presentation. In one embodiment, the entity or device pre-annotating the timeline may employ video analytics to detect 508 changes, such as scene changes, within the exemplar data and distinguish 510 multiple interesting sub-regions within the exemplar data. Video searching and/or video matching technologies may be applied 512 to identify longer versions of the distinguished 510 highlights within the exemplar data. Similarly, if the consumable data includes audio data such as a song or soundtrack, audio analytics (not illustrated) may be employed to identify where exemplar data may be found within the consumable data, as well as to find similar “sounds like” matches.

After identifying 506 interesting regions, in one embodiment, “fuzzy” matching may be performed 514 to allow finding portions of the consumable data that is “like” the exemplar data, and thus increase the number of identified interesting regions. To do so, for example, content analysis of video or audio data may be used to find other portions of the consumable data that is like the exemplar data. It will be appreciated fuzzy matching typically has an associated relevance rating to reflect a degree of relevance between a candidate match and the exemplar data. In one embodiment a required minimum degree of relevance, which can be arbitrarily set or determined with respect to the exemplar data, can be required for the candidate match to be considered an additional interesting region to be added to the identified 506 interesting regions.

Once interesting regions have been identified 506, 514 within the consumable data, these can be used to define the Collective Cut (CT), and they can be used to pre-annotate 516 the timeline for the consumable data. In one embodiment, the initially identified 506 regions are associated with a heavy weighting because the Director's Cut is considered to have high accuracy as to what is interesting.

FIG. 6 illustrates, according to one embodiment, continuing to apply multiple consumer access of consumable data to identify interesting regions for the Collective Cut (CT).

As illustrated there are interesting region collections 622, 624 corresponding to the combined input from FIG. 4 from monitoring at least two consumers. Illustrated regions 622 include regions 602, 606, 608, 612, 614, 616, 620 and these correspond to interesting region identification from a single consumer's input. Regions 622 includes regions 604, 610, 618 and these correspond to overlapping interesting regions from the two consumers' inputs. As discussed in FIG. 5, the single-input regions 602, 606, 608, 612, 614, 616, 620 may have an assigned weighting of 1, where the combined input regions 604, 610, 618 may have an assigned weighting of at least 2. It will be appreciated these weightings do not take into account any pre-annotation values or extra weighting assigned from consumers that access the entire consumable data.

Regions 624 include additional interesting regions 626-630 which may be identified by a consumer as discussed above in the other illustrated embodiments. In the FIG. 6 embodiment, regions 624 were identified by an additional consumer over those identifying regions 622. In the illustrated embodiment, the additional consumer is aware of the existing identified regions 622 and that selected regions 604, 610, 618 represent regions determined to have better reliability as being an interesting region. Such awareness can be presented in a variety of ways, such as graphically through the user interface of the device by which the additional consumer is accessing the consumable data, In one embodiment, the additional consumer is provided a user interface allowing adjustment to existing identified regions 602-620, or creation of new identified regions as discussed with respect to FIGS. 1-4. Thus, for example, the additional consumer may elect to refine existing annotations by way of adjusting start and/or end positions for the existing identified regions 602-620, or simply define new interesting regions. Either way, regions 624 may represent the end result of the additional user adjusting and/or creating new interesting regions 626-630, and these regions may be assigned a weighting (e.g., +1 for the additional consumer's effort) and the weightings combined with existing ratings.

FIG. 7 illustrates the result of all consumers of FIGS. 14, 6 identifying interesting regions and/or modifying regions identified by other consumers. Illustrated are regions 702-724 of which regions 704, 710, 716, and 722 represent regions of the consumable data that have been repeatedly identified by consumers as being interesting regions, where, in comparison, regions 702, 706, 708, 712, 714, 718, 720 and 724 represent regions that remain singly identified by consumers are being interesting. In one embodiment, regions that receive a sufficiently high weighting will be considered “true” interesting regions that will, for example for a movie, be presented to a consumer as movie highlights. In one embodiment, a consumer receiving a movie with such pre-determined highlights could opt to simply skip through the video and just watch the highlights. This consumer would rely on the collective consumer input having appropriately determined a good set of interesting regions to be consumed.

As more consumers contribute their refined and/or original identification of interesting regions within consumable data, the collection of interesting regions will continue to acquire more regions, each having varying weights. In one embodiment, a service provider, intermediary device along a transmission path or data path to the consumer, endpoint device utilized by the consumer, or other device, may elect to periodically condense region collections to reduce the number of regions being managed. In one embodiment, if two adjacent interesting regions have the same weight, they can be coalesced into one region. It will be appreciated consumer identification of interesting regions will not be precise, hence a tolerance may be applied when determining whether regions are adjacent. In one embodiment, multiple service providers may share interesting region identification consumable data common to the service providers to increase accuracy.

In one embodiment, when service providers have enough confidence in the collection of interesting regions, they may publish some or all of the identified regions, e.g., the service provider may elect to only release interesting regions that have been selected by a certain percentage of a targeted audience. Further, it will be appreciated that with the current ability to track a consumer's age and social, economic, religious, political, geographic, ethnic, food, etc. interests, a sufficiently large collection of interesting regions may be defined for and presented to specific audiences, e.g., a specific set of consumers sharing one or more desired characteristics. in one embodiment, service providers may provide customized annotations for specific customers having known interests and time availability, e.g., by way of questionnaires and/or monitored behavior or other meta data known about the consumer. The data known about the consumer can be used to select interesting regions relevant to the consumer and presented as the annotations for the consumable data. Regarding time availability, different consumers may have different amounts of available time to consumer data, such as the length of a bus or train ride to/from work, or other known time duration, and this may be a factor in the selection of regions for an annotation. For example, if one is short of time, an annotation may be defined such that it has only the highest rated region that fit within the time available to the consumer.

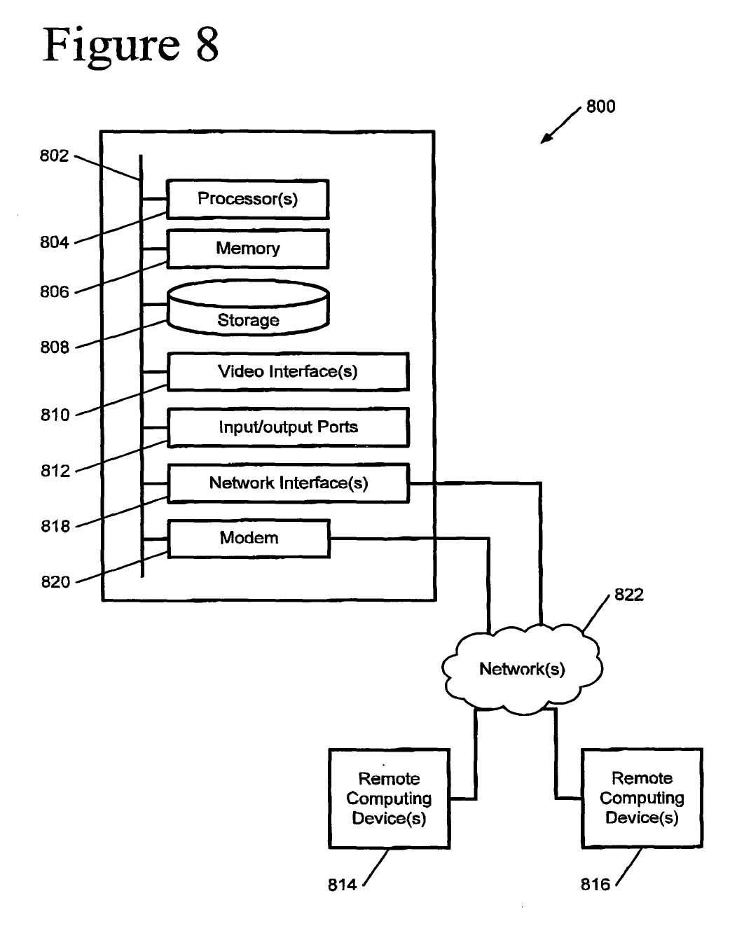

FIG. 8 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include computing devices such as personal computers, workstations, servers, portable computers, handheld devices, e.g., Personal Digital Assistant (PDA), telephone, tablets, etc., transmitters, receivers and/or other devices for accessing a d/or manipulating audio, visual, or other consumable data, as well as transportation devices, such as private or public transportation, e.g., automobiles, trains, cabs, etc.

Typically, the environment includes a machine 800 that includes a system bus 802 to which is attached processors 804, a memory 806, e.g., random access memory (RAM), read-only memory (ROM), or other state preserving medium, storage devices 808, a video interface 810, and input/output interface ports 812. It will be appreciated that while elements of the machine 800 may be referenced in the singular, multiple elements not illustrated may be present. The machine may be controlled, at least in part, by input from conventional input devices, such as keyboards, mice, etc., as well as by directives received from another machine, interaction with a virtual reality (VR) environment, biometric feedback, cooperative or aggregate learning or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 814, 816, such as through a network interface 818, modem 820, or other communicative coupling Machines may be interconnected by way of one or more physical and/or logical networks 822, such as an intranet, the Internet, local area networks, wide area networks, cloud network, distributed network, peer-to-peer network, and the like. One skilled in the art will appreciated that communication with network 822 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc. In some embodiments, multiple ones of networks 822 may be simultaneously utilized, and metrics such as cost, efficiency, preferences, power, etc. may be applied to control how particular ones of networks 822 are selected and how data is apportioned across multiple active networks.

The invention may be described by reference to or in conjunction with associated data including functions, procedures, data structures, application programs, etc. which when accessed by a machine results in machine 800 components performing tasks or defining abstract data types or low-level hardware contexts. Associated data may be stored in, for example, volatile and/or non-volatile memory 806, or in storage devices 808 and their associated storage media, including hard-drives, floppy-disks, optical storage, tapes, flash memory, memory sticks, digital video disks, biological storage, etc. Associated data may be delivered wholly or in part over transmission environments, including network 822, in the form of packets, serial data, parallel data, propagated signals sent and/or received by a tangible component, etc., and may be used in a compressed or encrypted format. Associated data may be used in a distributed environment, and stored locally and/or remotely for access by single or multi-processor machines.

Thus, for example, with respect to the illustrated embodiments, assuming machine 800 embodies a device utilized by a FIG. 4 consumer for consuming the consumable data, then remote machines 814, 816 may respectively be a cable television or satellite broadcast head end, Internet server, or other entity or device providing consumable data to the consumer, It will be appreciated remote machines 814, 816 may be configured like machine 800, and therefore may include many or all of the elements discussed for machine 800.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for annotating consumable data, comprising:
first monitoring a first consumption of the consumable data by a first consumer;
determining a first interesting region of the consumable data based at least in part on the first monitoring;
second monitoring a second consumption of the consumable data;
determining a second interesting region of the consumable data based at least in part on the second monitoring; and
determining a collection of interesting regions for the consumable data based at least in part on a refining of the first interesting region based at least in part on the second interesting region.

2. The method of claim 1, further comprising:
third monitoring a substantial number of consumers' consumption of the consumable data;
determining a corresponding substantial number of interesting regions of the consumable data based at least in part on the monitoring the substantial number of consumers; and
determining a collective cut for the consumable data based at least in part on similarities between selected ones of: the collection of interesting regions, and the substantial number of interesting regions.

3. The method of claim 2, further comprising:
assigning a weighting factor, associated with each consumer consuming the consumable data, to each interesting region identified by said each consumer;
determining a collection of regions based at least on common overlapping portions of said each interesting region identified by said each consumer; and
assigning weighting factors, to each interesting region of the collection, based at least in part on a combination of weighting factors for each of said common overlapping portions.

4. The method of claim 1, further comprising:
assigning a first weighting factor associated with the first consumer to the first interesting region;
assigning a second weighting factor associated with the second consumer to the second interesting region;
determining a third interesting region based at least in part on an overlap between the first and second interesting regions; and
assigning a third weighting factor to the third interesting region, the third weighting factor based at least in part on a combination of the first and second weighting factors.

5. The method of claim 1 wherein the second consumption is by a selected one of: the first consumer, or a second consumer.

6. The method of claim 1 wherein said determining the collection of interesting regions is based at least in part on applying interactive audience analytics to said monitoring.

7. The method of claim 1, wherein said monitoring of consumption includes selected ones of monitoring for duration of watched portions of the consumable data, and monitoring for skipped portions of the consumable data.

8. The method of claim 1 wherein the consumable data is a selected one or more of: audio data, video data, streamed data, pre-recorded data, or live data.

9. The method of claim 1 further comprising accessing the consumable data from selected ones of local storage, remote storage, cloud storage, peer-to-peer storage.

10. An article comprising a machine-accessible media having associated data, wherein the data, when accessed, results in a machine annotating consumable data by performing:
first monitoring a first consumption of the consumable data by a first consumer;
determining a first interesting region of the consumable data based at least in part on the first monitoring;
second monitoring a second consumption of the consumable data;
determining a second interesting region of the consumable data based at least in part on the second monitoring; and
determining a collection of interesting regions for the consumable data based at least in part on a refining of the first interesting region based at least in part on the second interesting region.

11. The article of claim 10 wherein the machine-accessible media further includes data, when accessed, results in the machine performing:
third monitoring a substantial number of consumers' consumption of the consumable data;
determining a corresponding substantial number of interesting regions of the consumable data based at least in part on the monitoring the substantial number of consumers; and
determining a collective cut for the consumable data based at least in part on similarities between selected ones of: the collection of interesting regions, and the substantial number of interesting regions.

12. The article of claim 10 wherein the machine-accessible media further includes data, when accessed, results in the machine performing:
assigning a weighting factor, associated with each consumer consuming the consumable data, to each interesting region identified by said each consumer;
determining a collection of regions based at least on common overlapping portions of said each interesting region identified by said each consumer, and
assigning weighting factors, to each interesting region of the collection, based at least in part on a combination of weighting factors for each of said common overlapping portions.

13. The article of claim 10 wherein the machine-accessible media further includes data, when accessed, results in the machine performing:
assigning a first weighting factor associated with the first consumer to the first interesting region;
assigning a second weighting factor associated with the second consumer to the second interesting region;
determining a third interesting region based at least in part on an overlap between the first and second interesting regions; and
assigning a third weighting factor to the third interesting region, the third weighting factor based at least in part on a combination of the first and second weighting factors.

14. An apparatus comprising:
means for monitoring multiple consumptions of a consumable data by multiple consumers;
means for determining multiple regions of interest within the consumable data based at least in part of the monitoring the multiple consumptions;
means for aggregating the multiple regions of interest within the consumable data; and
means for determining a collective cut for the consumable data based at least in part on the aggregating the multiple regions of interest.

15. The apparatus of claim 14, further comprising:
means for merging overlapping regions within the associated set of regions into a distinct set of regions of interest to be associated with the selected ones of the multiple consumers.

16. The apparatus of claim 14, wherein the means for determining multiple regions of interest within the consumable data further comprises:
means for associating a set of regions of interest for each of the consumers;
means for merging overlapping regions of interest within the set of regions into a distinct set of regions of interest associated with each consumer.

17. The apparatus of claim 14, further comprising:
means for providing the collective cut to an accessing apparatus configured with means for presenting the collective cut and means for monitoring consumption of the collective cut;
means for receiving data corresponding to monitored consumption by the accessing apparatus; and
means for refining the collective cut based at least in part on the data corresponding to monitored consumption.

18. A method for consuming consumable data, comprising:
receiving at least a portion of consumable data from a source, the source configurable to monitor consumption of the consumable data of multiple consumers, and identify interesting regions of the consumable data based at least in part on identifying intersections between regions of interest associated with the multiple consumers monitored consumption;
accessing the consumable data;
providing data characterizing the accessing to the source.

19. The method of claim 18:
wherein portions of the consumable data are received from multiple sources; and
wherein the data characterizing the accessing is provided to a selected one or more of the multiple sources.

20. The method of claim 18, further comprising receiving a collective cut for the consumable data.
